(19) United States
(12) Patent Application Publication
(10) Pub. No.: US 2013/0034634 A1
(43) Pub. Date: Feb. 7, 2013

(54) Stick Cookie Packaging System

(71) Applicant: Stephanie Cigana, Santa Fe Springs, CA (US)

(72) Inventor: Stephanie Cigana, Santa Fe Springs, CA (US)

(21) Appl. No.: 13/565,729

(22) Filed: Aug. 2, 2012

Related U.S. Application Data
(60) Provisional application No. 61/514,731, filed on Aug. 3, 2011.

(51) Int. Cl. B65D 5/52; A21D 13/00; B65D 85/00

(52) U.S. Cl. 426/104; 426/110; 426/134

(57) ABSTRACT

A bagged cookie is combined with a generally L-shaped holder having an upright portion and a base portion at about 90 degrees, and an elongate stick. The back side of the bagged cookie is adhered to the upright portion, preferably with double stick-back tape, and the lower side of the bagged cookie is resting on or near the base portion. The holder is configured to receive one end of an elongate stick, and the opposing end preferably engages a platform. Preferably there are several sets of the bagged cookies, holders, and elongate sticks engaged with the platform, forming a cookie bouquet.

### RELATED APPLICATION DATA

This application claims the priority date of provisional application No. 61/514,731 filed on Aug. 3, 2011 of the same title.

### BACKGROUND

Cookie bouquets, or a plurality of decorative cookies each on a stick, grouped and arranged in a basket or other display, have become a popular product. Previously it was difficult to mass distribute cookie bouquets, however, because placing the sticks into the cookies was labor intensive and there were quality problems. The accepted method was to place the cookie on a flat surface, place one's hand over the top of the cookie, and twist the stick while slowly inserting it into the cookie dough. The stick oftentimes would break through the bottom (or top) of the cookie requiring unsightly “patching,” or the result would be a thin wall between the stick and the exterior surface of the cookie leading to breakage of the cookies upon baking and shipping to the customer. See FIGS. 6-9 illustrating the prior art method.

Further, cookie manufacturers in some locations are not permitted by health department rules to bake cookies including sticks made of wood therein, and the temperature of the oven being an obvious problem for plastic sticks. Accordingly, to enable mass distribution of cookie bouquets, without high labor costs and quality problems, and within the confines of food health regulations, a better and cost-effective way of providing stick cookies for arrangement in the baskets or other display platforms was needed.

### SUMMARY

A cookie package includes a bagged cookie having and a holder with an upright portion and a base portion at about 90 degrees to each other or forming a generally L-shaped support. The back side of the bagged cookie is adhered to the upright portion, preferably with double stick-back tape, and the lower side of the bagged cookie is resting upon or near the base portion. Optionally, the bagged cookie is further adhered to the holder with a sticker overlying the upright portion and connecting to the back side of the bagged cookie. The holder is configured to receive one end of an elongate stick, preferably a support beneath the bottom side of the base of the holder, and the opposing end of the elongate stick preferably engages a platform. Preferably there are several of the bagged cookies, holders, and elongate sticks engaged with the platform, forming a cookie bouquet. The holders and the sticks are preferably clear plastic, or wooden sticks may be used if desired.

### BRIEF DESCRIPTION OF THE DRAWINGS

FIG. 1 is a perspective photograph of the top side of the bagged cookie packaged with a holder and a stick of the preferred embodiment.

FIG. 2 is a close up perspective photo of the bottom side of the bagged cookie combined with the holder and stick of the preferred embodiment.

FIG. 3 is a close in perspective photo of the holder and stick of the preferred embodiment.

FIG. 4 is a perspective photo of the holder separated from the stick.

FIG. 5A is a front view of the holder and the stick.

FIG. 5B is a side view of the holder and the stick.

FIG. 6 is a prior art photo of cookies ready to have a stick inserted.

FIG. 7 is a further prior art photo indicating the stick should be twisted as it is inserted.

FIG. 8 is a still further prior art photo showing the inserted stick having broken through the back side of the cookie.

FIG. 9 is a still further prior art photo indicating the back of the cookie being patched.

### DESCRIPTION

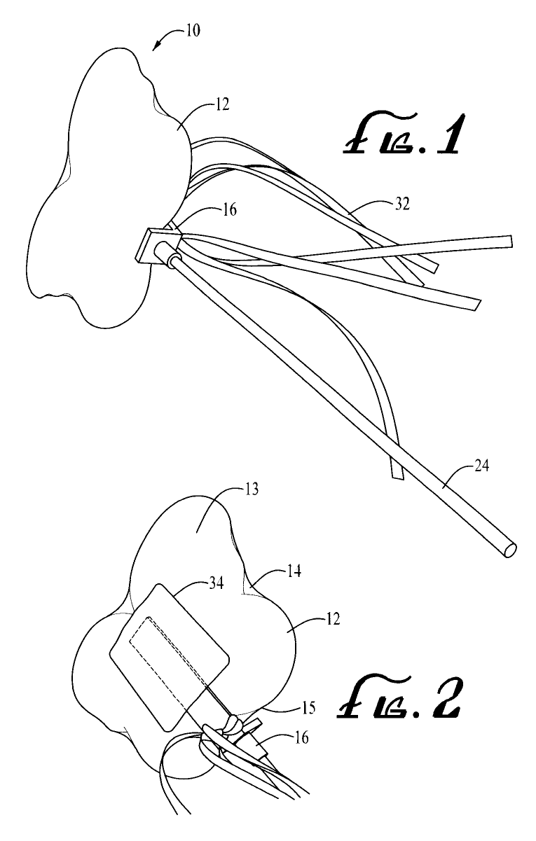

Referring to attached FIGS. 1-5, the preferred embodiment of the stick cookie packaging system may be described. As best shown in FIGS. 1, 2, the cookie package 10 includes a decorated bagged cookie 12 snugly encased in plastic wrap 14. On the backside 13 and lower edge 15 the cookie 12 is an L-shaped holder 16 at about 90 degrees, having a bottom side 21 and an upright portion 18 and a base portion 20 including a stick support 22. Attachable to the support 22 is an elongate stick 24, preferably with a friction or interference fit such that no glue is necessary to securely attach the two together.

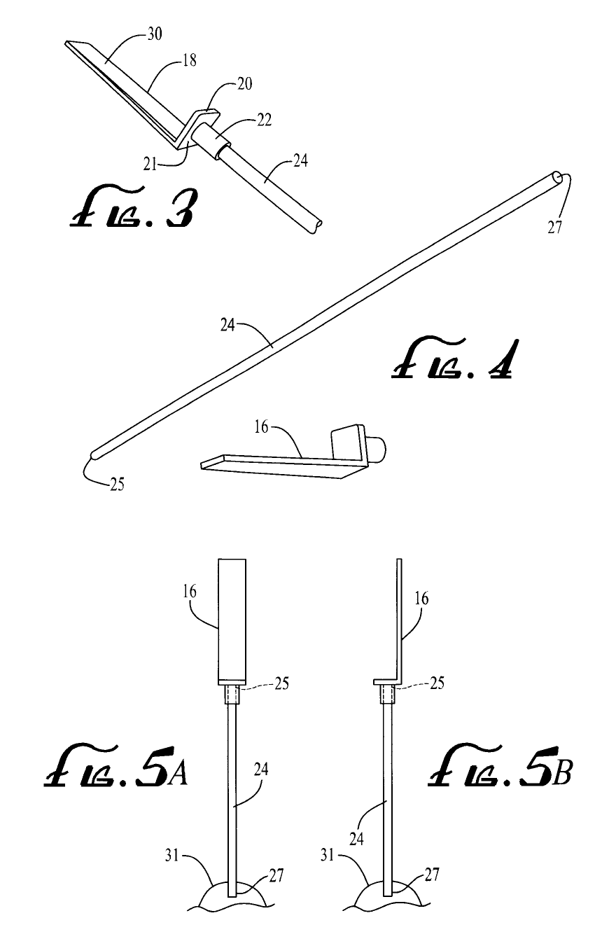

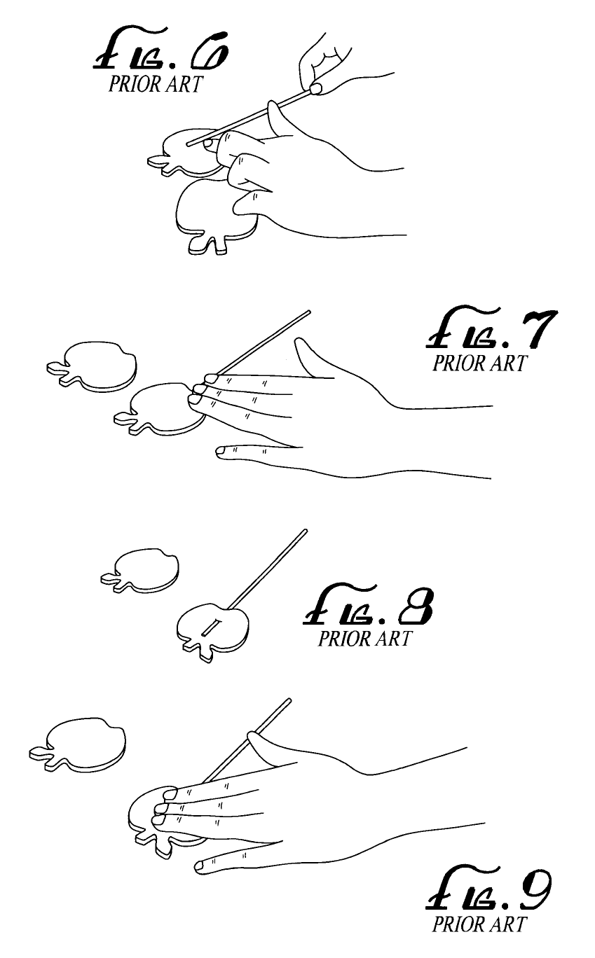

As best shown in FIGS. 3, 4, adhered to a front surface 26 of the upright portion 18 of the holder 16 is preferably double-sticky tape 28, for affixing the holder 16 to the bag 14 of the cookie 12. The holder 16 is preferably made of a transparent molded plastic material with the legs 18, 20 having a thickness of about 2 millimeters. The other preferred dimensions for the holder 16 are an upright portion 18 of about 75 mm and a base portion 20 of about 16 mm. For the stick 24 the preferred length is about 127 mm-280 mm, again clear plastic being the material of choice. Although wood sticks are acceptable as well.

The cookie 12 is made and bagged in a preferably clear plastic wrap as is any conventional cookie. Then a protective layer 30 is preferably removed from the double sticky back tape 28, and the backside 13 of the bagged cookie 12 adhered to the holder 16. Next, one end 25 of stick 24 is inserted into the stick support 22, and the cookie package 10 is ready to place, with others, by inserting the other end 27 into platform 37 a basket or other display forming a bouquet. Optionally, a set of streamers 32 may be added to further decorate each packaged cookie 10. Also optionally, a second stick 34 may be placed over the holder 16 and the back side 13 of the bagged cookie 12 to further secure them together.

While the present invention has been described with regards to a particular embodiment, it is recognized that additional variations of the present invention may be devised by persons skilled in the art without departing from the inventive concepts disclosed herein.

What is claimed is:

1. A cookie package comprising:
a bagged cookie having a back side and a lower edge;
a holder having an upright portion and a base portion having a bottom side, the upright and base portions arranged to form about a right angle;
the back side of the bagged cookie adhered to the upright portion, and the lower side of the bagged cookie proximate the base portion;
an elongate stick having one end and an opposing end; and
the holder having a support portion engaged with the one end of the elongate stick.

2. The cookie support package of claim 1 wherein the bagged cookie is adhered to the upright portion of the holder with double sticky-back tape.

3. The cookie support package of claim 2 wherein the bagged cookie is further adhered to the holder with a sticker overlying the upright portion and connecting to the back side of the bagged cookie.

4. The cookie support package of claim 1 wherein the upright portion is directly connected to the base portion forming a generally L-shaped holder.

5. The cookie support package of claim 1 wherein the support portion is directly connected to the bottom side of the base portion of the holder.

6. The cookie package of claim 1 further comprising a platform, and the opposing end of the elongate stick is engaged in the platform.

7. The cookie package of claim 6 further comprising a plurality of the bagged cookies adhered to a plurality of the holders, and a plurality of the elongate sticks engaged with the holders and the platform, thereby forming a cookie bouquet.

8. A cookie bouquet comprising:
a plurality of cookies;
a plurality of holders each having an upright portion and a base portion forming a generally L-shape;
the cookies secured to the upright portion proximate the base portion;
a plurality of elongate sticks each having one end and an opposing end; and,
the holders each having a support portion configured to receive the elongate sticks on the one end;
a platform, the elongate sticks on the other end engaging the platform.

9. The cookie support package of claim 8 wherein the cookies are bagged and adhered to the holders with adhesive tape.

10. The cookie support package of claim 8 wherein the holders are made of a clear plastic material.
